(19) United States
(12) Patent Application Publication
(10) Pub. No.: US 2024/0373233 A1
(43) Pub. Date: Nov. 7, 2024

(54) Lawful Interception in a Wireless Communication Network

(71) Applicant: Telefonaktiebolaget LM Ericsson (publ), Stockholm (SE)

(72) Inventors: Biagio Maione, Napoli (IT); Dario De Vito, Mercato San Severino (SA) (IT); Maurizio Iovieno, Salerno (IT)

(21) Appl. No.: 18/686,083

(22) PCT Filed: Nov. 19, 2021
(86) PCT No.: PCT/EP2021/082386

§ 371 Date: Feb. 23, 2024

Related U.S. Application Data
(60) Provisional application No. 63/236,650, filed on Aug. 24, 2021.

(51) Int. Cl. H04W 12/80; H04W 8/18

(52) U.S. Cl. CPC H04W 12/80; H04W 8/18

(57) ABSTRACT

A network device is configured to implement an Identity Event Function, IEF, (16) for lawful interception, LI, of communications in a wireless communication network (12). The network device detects an event that comprises a change in an association between a long-term subscription identifier and a temporary subscription identifier for a wireless communication device (14). Responsive to detecting the event, the network device generates a record (22) that indicates the long-term subscription identifier associated with the event and the temporary subscription identifier associated with the event. The network device transmits the record (22) to an Identity Caching Function, ICF, (18) configured to cache associations between long-term subscription identifiers and temporary subscription identifiers. The network device also transmits, to the ICF (18), information indicating that the record (22) is associated with the IEF (16).

### TECHNICAL FIELD

The application relates to a method performed by a network device configured to implement an Identity Event Function, IEF, for lawful interception, LI, of communications in a wireless communication network. The application also relates to a method performed by a network device configured to implement an Identity Caching Function, ICF, for LI, and a method performed by a network device configured to implement a Lawful Interception Provisioning Function, LIPF, for LI. Corresponding network devices, computer programs, carriers and non-transitory computer-readable storage media are also disclosed.

### BACKGROUND

Many countries require communication service providers (CSPs) to enable Lawful Interception (LI) of communications. Lawful Interception (LI) allows law enforcement agencies (LEAs) to obtain communications data pursuant to lawful authority, e.g., a warrant, for the purpose of analysis or evidence. See, e.g., 3GPP Technical Specification (TS) 33.127 v17.1.0 for LI as specified by 3GPP.

Security measures implemented by CSPs complicate Lawful Interception. For example, a wireless communication network may use temporary subscription identifiers for wireless communication devices in order to safeguard against malicious attempts to track devices based on their long-term subscription identifiers. In this case, a CSP's LI system must keep track of which long-term subscription identifiers are associated with which temporary subscription identifiers. This way, for instance, when an LEA requests communications data for a target subscriber, the LI system can selectively provide data for communications that were performed using the temporary subscription identifier associated with that subscriber.

In some LI systems, such as ones that conform to the architecture specified by TS 33.127 v17.1.0, an Identity Event Function (IEF) tracks changes in associations between long-term subscription identifiers and temporary subscription identifiers. An Identity Caching Function (ICF) caches these identifier associations, for later retrieval. Although this distribution of functionality between the IEF and ICF advantageously allows the IEF and ICF to be implemented separately, e.g., at different locations in the system, it complicates management of the identifier associations.

### SUMMARY

One object of the invention is to enable a lawful interception system with multiple Identity Event Functions (IEFs) to manage associations between long-term subscription identifiers and temporary subscription identifiers on an IEF by IEF basis, e.g., to manage identifier associations detected by a specific IEF. Alternatively or additionally, an object of the invention is to enable a lawful interception system to selectively delete, from the cache of an Identity Caching Function (ICF), only those identifier associations detected by one or more specified IEFs.

Some embodiments herein enable management of identifier associations on an IEF by IEF basis, e.g., selective deletion of cached identifier associations on an IEF by IEF basis. Some embodiments in this regard cache an identifier association at the ICF in relation to the IEF that detected that identifier association, e.g., so that the identifier association(s) detected by that IEF can be identified and selectively deleted. In support of this functionality, an IEF that transmits, to the ICF, a record of a change in an identifier association also transmits to the ICF information that associates the provided record with that IEF, e.g., in the form of an IEF identity included in the record. The ICF in turn caches the identifier association in a way that ties the cached identifier association with that IEF, e.g., in association with an IEF identity of the IEF. This way, upon request, the ICF can selectively delete cached identifier associations on an IEF by IEF basis, e.g., selectively delete cached identifier associations for a certain IEF.

More particularly, embodiments herein include a method performed by a network device configured to implement an Identity Event Function, IEF, for lawful interception, LI, of communications in a wireless communication network. The method comprises detecting an event that comprises a change in an association between a long-term subscription identifier and a temporary subscription identifier for a wireless communication device, responsive to detecting the event, generating a record that indicates the long-term subscription identifier associated with the event and the temporary subscription identifier associated with the event, transmitting the record to an Identity Caching Function, ICF, configured to cache associations between long-term subscription identifiers and temporary subscription identifiers, and transmitting, to the ICF, information indicating that the record is associated with the IEF.

In some embodiments, the information indicating that the record is associated with the IEF comprises an IEF identity. In one or more of these embodiments, the IEF identity is included in the record, wherein the IEF identity identifies the IEF, wherein the information is transmitted to the ICF by transmitting the record to the ICF. In one or more of these embodiments, transmitting the information comprises transmitting the IEF identity to the ICF in the same message as the record. In one or more of these embodiments, the IEF identity is an identity of the network equipment. In one or more of these embodiments, the IEF identifier is a Universally Unique Identifier, UUID.

In some embodiments, the record includes a first field that indicates the long-term subscription identifier associated with the event, a second field that indicates the temporary subscription identifier associated with the event, and a third field that includes the information indicating that the record is associated with the IEF.

In some embodiments, the event is association of the temporary subscription identifier to the long-term subscription identifier. Alternatively, the event is disassociation of the temporary subscription identifier to the long-term subscription identifier.

In some embodiments, the long-term subscription identifier is a Subscription Long-term Identifier, SUPI.

In some embodiments, the long-term subscription identifier is an International Mobile Subscriber Identity, IMSI.

In some embodiments, the long-term subscription identifier is a network specific identifier, a Global Line Identifier, GLI, or a Global Cable Identifier, GCI. In this case, the long-term subscription identifier takes the form of a Network Access Identifier.

In some embodiments, the temporary subscription identifier is a 5G Global Unique Temporary Identifier, 5G-GUTI.

In some embodiments, the method further comprises generating the information indicating that the record is associated with the IEF.

In some embodiments, the method further comprises receiving, from a LI Provisioning Function, LIPF, a request to activate the IEF, and transmitting, to the LIPF, a response that indicates successful activation of the IEF and that indicates an IEF identity identifying the IEF.

Other embodiments herein include a method performed by a network device configured to implement an Identity Caching Function, ICF, for lawful interception, LI, of communications in a wireless communication network. The method comprises receiving, from an Identity Event Function, IEF, a record for an event that comprises a change in an association between a long-term subscription identifier and a temporary subscription identifier for a wireless communication device, wherein the record indicates the long-term subscription identifier associated with the event and the temporary subscription identifier associated with the event, and receiving, from the IEF, information indicating that the record is associated with the IEF.

In some embodiments, the information indicating that the record is associated with the IEF comprises an IEF identity. In one or more of these embodiments, the IEF identity is included in the record. In this case, the IEF identity identifies the IEF, and the information is received from the ICF by receiving the record from the ICF. In one or more of these embodiments, receiving the information comprises receiving the IEF identity from the ICF in the same message as the record. In one or more of these embodiments, the IEF identity is an identity of the network equipment. In one or more of these embodiments, the IEF identifier is a Universally Unique Identifier, UUID.

In some embodiments, the record includes a first field that indicates the long-term subscription identifier associated with the event, a second field that indicates the temporary subscription identifier associated with the event, and a third field that includes the information indicating that the record is associated with the IEF.

In some embodiments, the event is association of the temporary subscription identifier to the long-term subscription identifier. Alternatively, the event is disassociation of the temporary subscription identifier to the long-term subscription identifier.

In some embodiments, the long-term subscription identifier is a Subscription Long-term Identifier, SUPI.

In some embodiments, the long-term subscription identifier is an International Mobile Subscriber Identity, IMSI.

In some embodiments, the long-term subscription identifier is a network specific identifier, a Global Line Identifier, GLI, or a Global Cable Identifier, GCI. In this case, the long-term subscription identifier takes the form of a Network Access Identifier.

In some embodiments, the temporary subscription identifier is a 5G Global Unique Temporary Identifier, 5G-GUTI.

In some embodiments, the method further comprises storing the association provided by the IEF in the record.

In some embodiments, storing the association comprises storing the association per IEF.

In some embodiments, storing the association comprises storing the association in association with an IEF identity that identifies the IEF. In one or more of these embodiments, the method further comprises receiving, from an Identity Query Function, IQF, an identifier association query request, searching identified associations stored at the ICF to establish a match, based on values received in the identifier association query request, and transmitting, to the IQF, a response to the identifier association query request indicating one or more matching identifier associations.

In some embodiments, the method further comprises receiving a request to delete any identifier associations received in events for one or more IEFs. In one or more of these embodiments, the request includes one or more respective IEF identities that identify the one or more IEFs. In one or more of these embodiments, the request is a request to delete any identifier associations received in events for all IEFs. In one or more of these embodiments, the method further comprises responsive to the request, deleting any identifier associations received in events for the one or more IEFs.

Other embodiments herein include a method performed by a network device configured to implement an Identity Caching Function, ICF, for lawful interception, LI, of communications in a wireless communication network. The method comprises receiving a request to delete any identifier associations received in events for one or more Identity Event Functions, IEFs. In this case, the request includes one or more respective IEF identities that identify the one or more IEFs, and the identifier associations are each an association between a long-term subscription identifier and a temporary subscription identifier for a wireless communication device.

In some embodiments, the method further comprises deleting any identifier associations received in events for the one or more IEFs.

In some embodiments, the long-term subscription identifier is a Subscription Long-term Identifier, SUPI.

In some embodiments, the long-term subscription identifier is an International Mobile Subscriber Identity, IMSI.

In some embodiments, the long-term subscription identifier is a network specific identifier, a Global Line Identifier, GLI, or a Global Cable Identifier, GCI. In this case, the long-term subscription identifier takes the form of a Network Access Identifier.

In some embodiments, the temporary subscription identifier is a 5G Global Unique Temporary Identifier, 5G-GUTI.

Other embodiments herein include a method performed by a network device configured to implement a Lawful Interception Provisioning Function, LIPF, for lawful interception, LI, of communications in a wireless communication network. The method comprises transmitting, to an Identity Event Function, IEF, a request to activate the IEF, and receiving, from the IEF, a response that indicates successful activation of the IEF and that indicates an IEF identity identifying the IEF.

In some embodiments, the IEF identity is an identity of network equipment that implements the IEF.

In some embodiments, the IEF identity is a Universally Unique Identifier, UUID.

In some embodiments, the method further comprises transmitting, to an Identity Caching Function, ICF, a request to delete any identifier associations in events for one or more IEFs. In this case, the request includes one or more respective IEF identities that identify the one or more IEFs, and the identifier associations are each an association between a long-term subscription identifier and a temporary subscription identifier for a wireless communication device.

In some embodiments, the method further comprises transmitting, to an Identity Caching Function, ICF, a request to delete any identifier associations in events for the IEF. In this case, the request includes the IEF identity received in the response.

In some embodiments, the long-term subscription identifier is a Subscription Long-term Identifier, SUPI.

In some embodiments, the long-term subscription identifier is an International Mobile Subscriber Identity, IMSI.

In some embodiments, the long-term subscription identifier is a network specific identifier, a Global Line Identifier, GLI, or a Global Cable Identifier, GCI. In this case, the long-term subscription identifier takes the form of a Network Access Identifier.

In some embodiments, the temporary subscription identifier is a 5G Global Unique Temporary Identifier, 5G-GUTI.

Other embodiments herein include a method performed by a network device configured to implement a Lawful Interception Provisioning Function, LIPF, for lawful interception, LI, of communications in a wireless communication network. The method comprises transmitting, to an Identity Caching Function, ICF, a request to delete any identifier associations in events for one or more IEFs. In this case, the request includes one or more respective IEF identities that identify the one or more IEFs, and the identifier associations are each an association between a long-term subscription identifier and a temporary subscription identifier for a wireless communication device.

In some embodiments, the one or more IEF identities are one or more identities of one or more network equipment that implement the one or more IEFs.

In some embodiments, the one or more IEF identities are each a Universally Unique Identifier, UUID.

In some embodiments, the long-term subscription identifier is a Subscription Long-term Identifier, SUPI.

In some embodiments, the long-term subscription identifier is an International Mobile Subscriber Identity, IMSI.

In some embodiments, the long-term subscription identifier is a network specific identifier, a Global Line Identifier, GLI, or a Global Cable Identifier, GCI. In this case, the long-term subscription identifier takes the form of a Network Access Identifier.

In some embodiments, the temporary subscription identifier is a 5G Global Unique Temporary Identifier, 5G-GUTI.

Other embodiments herein include a network device configured to implement an Identity Event Function, IEF, for lawful interception, LI, of communications in a wireless communication network. The network device is configured to perform the method performed by a network device configured to implement an Identity Event Function, IEF, for lawful interception, LI, of communications in a wireless communication network.

Other embodiments herein include a network device configured to implement an Identity Event Function, IEF, for lawful interception, LI, of communications in a wireless communication network. The network device comprises communication circuitry and processing circuitry configured to perform the method performed by a network device configured to implement an Identity Event Function, IEF, for lawful interception, LI, of communications in a wireless communication network.

Other embodiments herein include a network device configured to implement an Identity Caching Function, ICF, for lawful interception, LI, of communications in a wireless communication network. The network device is configured to perform the method performed by a network device configured to implement an Identity Caching Function, ICF, for lawful interception, LI, of communications in a wireless communication network.

Other embodiments herein include a network device configured to implement an Identity Caching Function, ICF, for lawful interception, LI, of communications in a wireless communication network. The network device comprises communication circuitry and processing circuitry configured to perform the method performed by a network device configured to implement an Identity Caching Function, ICF, for lawful interception, LI, of communications in a wireless communication network.

Other embodiments herein include a network device configured to implement a Lawful Interception Provisioning Function, LIPF, for lawful interception, LI, of communications in a wireless communication network. The network device is configured to perform the method performed by a network device configured to implement a Lawful Interception Provisioning Function, LIPF, for lawful interception, LI, of communications in a wireless communication network.

Other embodiments herein include a network device configured to implement a Lawful Interception Provisioning Function, LIPF, for lawful interception, LI, of communications in a wireless communication network. The network device comprises communication circuitry and processing circuitry configured to perform the method performed by a network device configured to implement a Lawful Interception Provisioning Function, LIPF, for lawful interception, LI, of communications in a wireless communication network.

Other embodiments herein include a computer program comprising instructions which, when executed by at least one processor of a network device, causes the network device to carry out the steps of any of the network devices described above. In some embodiments, a carrier containing the computer program is one of an electronic signal, optical signal, radio signal, or computer readable storage medium.

Other embodiments herein include a non-transitory computer-readable storage medium on which is stored instructions that, when executed by a processor of a network device, causes the network device to perform the steps of any of the network devices described above.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of a high-level architecture of a lawful intercept system according to some embodiments.

FIG. 3 is a block diagram of functional entities in a lawful intercept system according to some embodiments.

FIG. 4 is a block diagram showing interfaces impacted by one or more embodiments for a lawful intercept system.

FIG. 5 is a call flow diagram of operations to generate and use an IEF identity with the purpose to enable an LIPF to select an ICF cache selectively, according to some embodiments.

FIG. 6 is a logic flow diagram of a method performed by a network device configured to implement an Identity Event Function, IEF, for lawful interception of communications in a wireless communication network according to some embodiments.

FIG. 7 is a logic flow diagram of a method performed by a network device configured to implement an Identity Event Function, IEF, for lawful interception of communications in a wireless communication network according to other embodiments.

FIG. 8 is a logic flow diagram of a method performed by a network device configured to implement an Identity Caching Function, ICF, for lawful interception of communications in a wireless communication network according to some embodiments.

FIG. 9 is a logic flow diagram of a method performed by a network device configured to implement an Identity Caching Function, ICF, for lawful interception, LI, of communications in a wireless communication network according to other embodiments.

FIG. 10 is a logic flow diagram of a method performed by a network device configured to implement a Lawful Interception Provisioning Function, LIPF, for lawful interception, LI, of communications in a wireless communication network according to some embodiments.

FIG. 11 is a block diagram of a network device according to some embodiments.

FIG. 12 is a block diagram of a communication system in accordance with some embodiments.

FIG. 13 is a block diagram of a user equipment according to some embodiments.

FIG. 14 is a block diagram of a network node according to some embodiments.

FIG. 15 is a block diagram of a host according to some embodiments.

FIG. 16 is a block diagram of a virtualization environment according to some embodiments.

FIG. 17 is a block diagram of a host communicating via a network node with a UE over a partially wireless connection in accordance with some embodiments.

### DETAILED DESCRIPTION

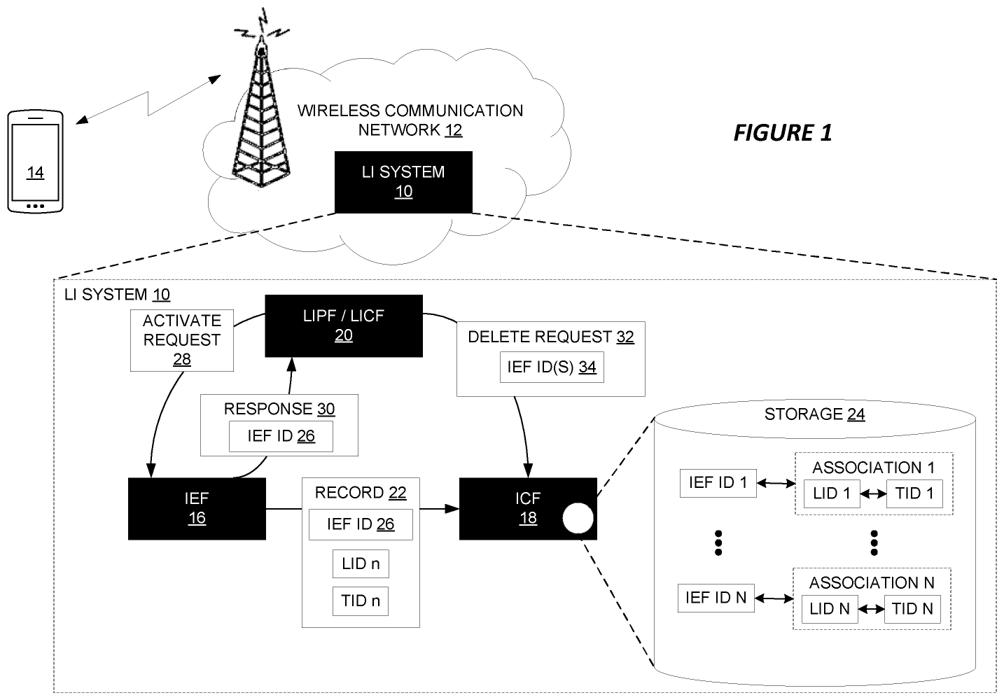

As shown in FIG. 1, a wireless communication network 12 provides wireless communication service to wireless communication devices 14. The wireless communication network 12 does so on the basis of subscriptions to receive such service. Indeed, in order to receive wireless communication service from the wireless communication network 12, a wireless communication device 14 provides the wireless communication network 12 with credentials for authenticating that the wireless communication device 14 holds a subscription to receive that service.

A subscription to the wireless communication network 12 is identified by a long-term subscription identifier (LID). In some embodiments, a long-term subscription identifier is assigned to a subscription, for identifying that subscription, over a long term, e.g., so as to persist across multiple communication sessions. In fact, in some embodiments, a long-term subscription identifier amounts to a permanent subscription identifier that permanently identifies the subscription, e.g., for the lifetime of the subscription. In a 5G network, for example, a long-term subscription identifier may take the form of a Subscription Permanent Identifier (SUPI). In these and other embodiments, a long-term subscription identifier may be an International Mobile Subscriber Identity (IMSI). Or, a long-term subscription identifier may be a network specific identifier, a Global Line Identifier (GLI), or a Global Cable Identifier (GCI), e.g., in which case the long-term subscription identifier takes the form of a Network Access Identifier (NAI).

For security reasons, though, the wireless communication network 12 avoids transmission of long-term subscription identifiers over the air interface when possible, e.g., to prevent an eavesdropper from tracking a wireless communication device by observing the device's long-term subscription identifier over the air interface. The wireless communication network 12 in this regard associates a long-term subscription identifier with a temporary subscription identifier. A temporary subscription identifier is assigned to a subscription, for identifying that subscription, on a temporary basis, e.g., over a shorter term than the long-term subscription identifier, such as for the lifetime of a single communication session. The wireless communication network 12 may therefore dynamically change which temporary subscription identifier is associated with a given long-term subscription identifier. In a 5G network, for instance, a temporary subscription identifier may be a 5G Global Unique Temporary Identifier (5G-GUTI).

In this context, FIG. 1 shows a Lawful Interception (LI) system 10 for use with the wireless communication network 12. As shown, the LI system 10 includes an Identity Event Function (IEF) 16, an Identity Caching Function (ICF) 18, and an LI Provisioning Function (LIPF) 20. Although not shown, in some embodiments, the LI system 10 may include multiple IEFs, e.g., co-located with different Points of Interception (POIs) in the LI system 10.

An IEF 16 as shown may detect an event that comprises a change in an association between a long-term subscription identifier (LID) and a temporary subscription identifier (TID) for a wireless communication device 14. For example, the IEF 16 may detect an association event whereby a new temporary subscription identifier is allocated to the wireless communication device 14, such that the new temporary subscription identifier becomes associated with the wireless communication device's long-term subscription identifier. Or, the IEF 16 may detect a disassociation event whereby a long-term subscription identifier and a temporary subscription identifier that are associated with one another become disassociated.

Regardless of the particular type of event detected, the IEF 16 generates a record 22 of the event. The record 22 as shown indicates a long-term subscription identifier (LID n) associated with the detected event and indicates a temporary subscription identifier (TID n) associated with the detected event. The record 22 may also indicate the type of the event detected, e.g., as being an association event or a disassociation event. With this record 22 generated, the IEF 16 correspondingly transmits the record 22 to the ICF 18.

The ICF 18 is configured to cache identifier associations, i.e., associations between long-term subscription identifiers and temporary subscription identifiers. The ICF 18 as shown, for example, stores identifier associations in storage 24, e.g., in the form of a cache. In the example shown, association 1 is the association between LID 1 and TID 1, association N is the association between LID N and TID N, etc. Based on these stored identifier associations, the ICF 18 can field queries for which long-term subscription identifier is associated with a target temporary subscription identifier and/or queries for which temporary subscription identifier is associated with a target long-term subscription identifier.

Notably, according to some embodiments, the IEF 16 also transmits to the ICF 18 information indicating that the record 22 is associated with the IEF 16. As shown in the example of FIG. 1, the information may comprise an IEF identity (ID) 26 that identifies the IEF 16. In embodiments where the IEF 16 is specific to a certain network device or network function, the IEF ID 26 may take the form of an identity of that certain network device or network function. In one 5G embodiment, for example, the IEF 16 is specific to a certain Access and Mobility Function (AMF) and the IEF ID 26 takes the form of an AMF ID. In these and other embodiments, the IEF ID 26 may be a Universally Unique Identifier (UUID).

In one embodiment, the information indicating that the record 22 is associated with the IEF 16 is included in the record 22 itself. For example, the record 22 may include a first field that indicates the long-term subscription identifier associated with the event, a second field that indicates the temporary subscription identifier associated with the event, and a third field that includes the information indicating that the record 22 is associated with the IEF 16. Where the information comprises an IEF ID 26, for instance, the third field may be an IEF ID field. Regardless, in this case, since the information is included in the record 22 itself, the IEF 16 transmits the information to the ICF 18 by transmitting the record 22 to the ICF 18.

In another embodiment, the information indicating that the record 22 is associated with the IEF 16 is not included in the record 22 itself. For example, in some embodiments, the IEF 16 transmits the information to the ICF 18 by transmitting the information to the ICF 18 in the same message as the record 22, i.e., so that inclusion of the information in the same message as the record 22 indicates that the record is associated with the IEF 16.

Note that, in some embodiments, the IEF 16 itself generates the information indicating that the record 22 is associated with the IEF 16. Where the information is an IEF ID 26, for instance, the IEF 16 may generate that IEF ID 26 itself. For example, the IEF 16 may have generated the information upon activation of the IEF 16, e.g., at the request of the LIPF 20. In some embodiments as shown, for instance, the LIPF 20 may have previously transmitted a request 28 to activate the IEF 16. And, upon or as part of activating the IEF 16, the IEF 16 may have generated the IEF ID 26 identifying the IEF 16. In fact, in some embodiments, the IEF 16 transmits, to the LIPF 20, a response 30 to the request 28 that indicates successful activation of the IEF 16 and that indicates the IEF ID 26, e.g., for use by the LIPF 20 in managing the identifier associations.

Regardless of the nature of the information or how it is transmitted to the ICF 18, the ICF 18 may store the association provided/indicated by the IEF 16 in the record 22. Where the record 22 is of an association event, for example, the ICF 18 may store the association between LID n and TID n in storage 24 as an active association. By contrast, where the record 22 is of a disassociation event, the ICF 18 may store (or continue to store) the association between LID n and TID n but mark the association for deletion, e.g., after a cache time. With the identifier associations so stored, the ICF 18 may field queries for identifier associations, e.g., from an Identity Query Function (not shown). The ICF 16 may for instance search identifier associations 1 . . . N stored at the ICF 18 to establish a match, based on values received in an identifier association query request, and then transmit a response to the query request indicating the one or more matching identifier associations.

Notably, equipped with information that the record 22 is associated with the IEF 16, the ICF 18 in some embodiments stores the associations per IEF, e.g., by storing the identifier associations in association with respective IEF IDs. As shown in FIG. 1, for instance, each identifier association 1 . . . N in the storage 24 is associated a respective IEF ID 1 . . . N. This may advantageously enable management of the identifier associations on an IEF by IEF basis.

In some embodiments as shown, for example, the LIPF 20 may transmit, to the ICF 18, a request 32 to delete any identifier associations received in events for one or more IEFs. The LIPF 20 may do so as part of proxying for a LI Control Function (LICF). Regardless, the request 32 may include one or more respective IEF IDs 34 that identify those one or more IEFs. Having stored the identifier associations 1 . . . N in relation to the IEF IDs 1 . . . N, the ICF 18 may selectively delete the identifier association(s) received in events for the one or more IEFs. In some embodiments, such deletion occurs immediately in response to the request 32, as opposed to the deletion happening only after a certain amount of time having passed since being marked for deletion.

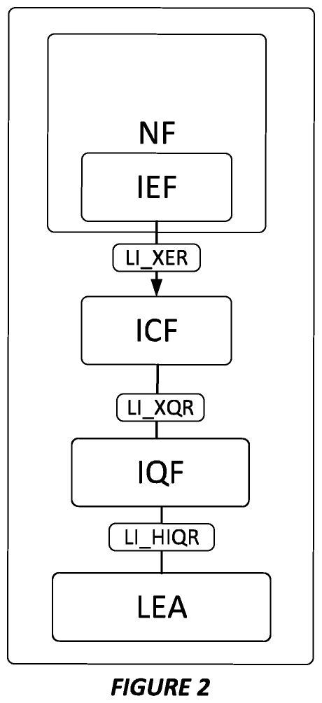

Consider now a concrete example of some embodiments herein in the context where the LI system 10 operates as specified by 3GPP TS 33.127 and 33.128. According to TS 33.127 for LI purposes, communication service providers (CSPs) are required to be able to provide real-time association between temporary and long-term identifiers where the use of such identifier associations impact the ability of a law enforcement agency (LEA) to uniquely identify a user equipment (UE), subscriber, or true permanent identifiers associated with a service. One set of capabilities which allows CSPs to report such associations to LEAs, based on proper legal warrant/authorization, requires the high-level architecture depicted in FIG. 2.

The Identifier Event Function (IEF) in FIG. 2 provides the Identifier Caching Function (ICF) with the events necessary to answer the identifier association queries from the Identifier Query Function (IQF). The IQF is the function responsible for receiving and responding to dedicated LEA real-time queries for identifier associations. The IQF may be a sub-function of the Administration Function (ADMF). LEAs are therefore able to issue real-time queries to the IQF, which in turn queries the ICF. On receiving a valid query, then, the IQF shall query the ICF in order to obtain the required mapped identities. The IQF shall be able to support both association from long-term identifiers to temporary identifiers and from temporary identifiers to long-term identifiers.

The IEF in FIG. 2 is the function responsible for observing and detecting identifier association changes within its parent network function (NF) and providing those changes in the form of event records to the ICF over the LI_XER interface. The IEF shall be able to provide event records to the ICF when associations are updated. Association events include both allocation or deallocation events for temporary identifiers managed by the IEF's parent NF and for identifier association which are registered or deregistered in the IEF's parent NF but the identifier allocation is not controlled by that NF.

In some embodiments, a single ICF for all IEFs is supported. Note also that IEFs may be co-located with POIs but may also be placed in other NFs where the NFs handling identifier association do not otherwise support POI functionality.

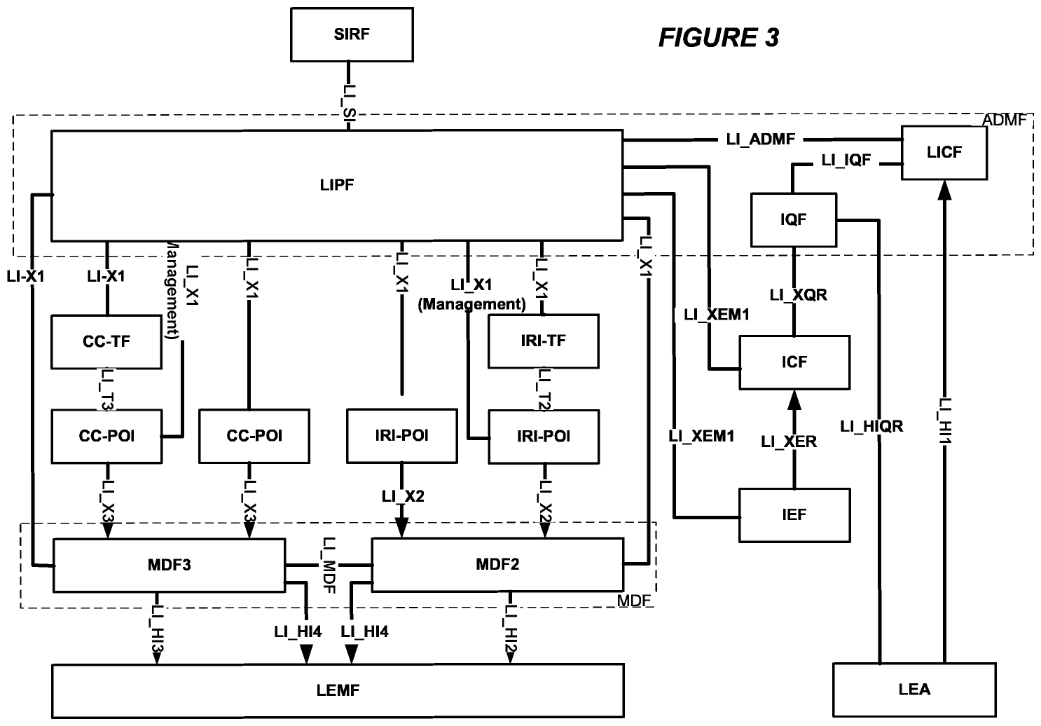

FIG. 3 shows the placement of the functional entities mentioned above in the general LI architecture according to some embodiments:

The IEF shall support activation and deactivation of IEF association reporting capabilities, as controlled by the LI Control Function (LICF) (proxied by the LIPF) over the LI_XEM1 interface. When IEF reporting capabilities are deactivated, the IEF shall immediately stop sending event records to the ICF.

The ICF is the LI function responsible for caching of identifier associations provided by the IEF in event records received over the LI_XER and answering queries from the IQF received over LI_XQR. The ICF shall support association queries from both temporary identities to permanent identities and from permanent identities to temporary identities. The ICF shall store identifier associations received from the IEF and hold them indefinitely as active associations until: (i) A new association event is received which updates a previous association: (ii) A disassociation event is received for a stored association; (iii) A CSP defined maximum age is reached.

Some embodiments herein enable the IEF 16 to support immediate deletion of identifier associations received in events for one or more IEF(s) when requested to do so by the LICF (proxied by the LIPF) over LI_XEM1. Some embodiments in this regard provide capabilities for allowing the LICF (proxied by the LIPF) to request the ICF to execute deletion of identifier associations received for one or more IEF(s). For example, some embodiments enhance the LI_XEM1 protocol to communicate an IEF ID (e.g., AMF ID) for which deletion of identity association shall be done.

Generally, then, some embodiments provide enhancements to the existing relevant interfaces and protocols, in order to support immediate deletion of identifier associations in the ICF 18 for one or more IEF(s) 16, when requested by the LIPF 20.

A first enhancements is the definition of a message over LI_XEM1 to allow the LIPF 20 to order the immediate deletion of identifier associations in the ICF 18 for one or more IEF(s) 16.

According to some embodiments, the IEF 16 includes an IEFid in every association message sent to the ICF 18, to be stored together with the association record created in the ICF 18. The IEFid can then be used by the LIPF 20 over the LI_XEM1 interface towards the ICF 18 to request deletion of records in the ICF 18 for given IEF(s) 16. This could include as a particular case a string such as “All” to request the deletion of all records in the ICF 18.

The IEFid may be known at the LIPF 20 as part of preconfiguration, based on LI_X0 interface. Other embodiments herein propose that the IEFid is generated by the IEF 16 and included over the LI_XEM1 interface between the IEF 16 and LIPF 20 in the response message 30 sent by the IEF 16 to the LIPF 20 when activation of IEF 16 is ordered by the LIPF 20. A further alternative is that the IEFid is provided by the System Information Retrieval Function (SIRF) to the LIPF 20 when the parent NF is instantiated. It has to be noted however that the way the IEFid is known at the LIPF 20 does not affect the other aspects herein.

Embodiments herein alternatively or additionally define a new message over LI_XEM1 to allow the LIPF 20 to order the immediate deletion of identifier associations in the ICF 18 for one or more IEF(s) 16. This message includes one or more instances of a parameter identifying for which IEF 16 the deletion of associations is required at the ICF 18.

Generally, then, embodiments herein may provide an additional parameter, carrying an IEFid, that the IEF 16 includes in every association message sent to the ICF 18, to be stored together with the association record created in the ICF 18. Other aspects herein alternatively or additionally include the generation of an IEF Id by the IEF 16 which is then added as new parameter to the response message sent by the IEF 16 to the LIPF 20 when activation of IEF 16 is ordered by the LIPF 20.

Certain embodiments may provide one or more of the following technical advantage(s). Some embodiments provide enhanced protocols and interfaces related to Identity Caching in order to fulfill architectural/functional requirements. Having the possibility to delete all the identity associations related to one or more IEFs in the ICF 18 allows to have complete and correct ICF management capabilities from the LIPF 20, also to comply with possible privacy requirements/regulations in terms of storing/deleting subscriber information.

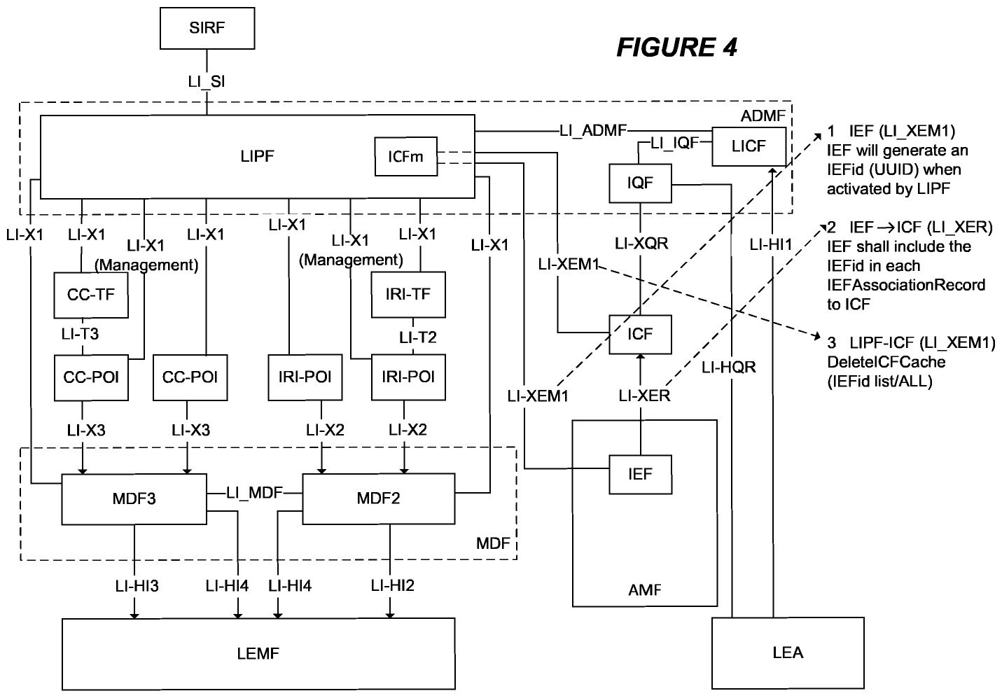

According to some embodiments, the proposed impacted interfaces to notify ICF based on IEFid and delete ICF are depicted in FIG. 4 and consist of the following steps:
(1) The IEF functional entity generates the IEFid (UUID format) when activated by LIPF and sends it back in the response
(2) The IEF will include the IEFid in the IEFAssociationRecord. The ICF will tag the stored association record with IEFid.
(3) The LIPF may decide to delete an ICF cache for one or more IEFs, e.g., by specifying a list of one or more IEF IDs or by specifying that the complete cache is to be deleted for all IEFs.

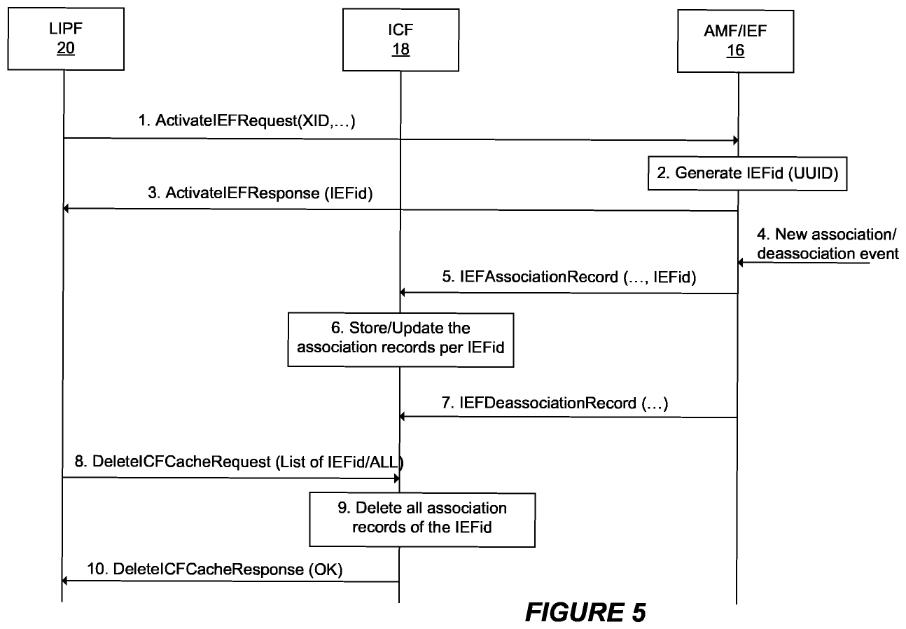

The flow chart in FIG. 5 shows the sequence of operations to generate and use the IEFid with purpose to enable LIPF to delete the ICF cache selectively for one or more IEF IDs, according to some embodiments.

A prerequisite to the above flow is that the ICF is activated by LIPF as indicated by TS 3GPP 33.127.

As shown in FIG. 5, the LIPF transmits an ActivatelEFRequest message to the AMF/IEF, requesting activation of an IEF (Step 1). The AMF/IEF activates an IEF and generates a corresponding IEFid, e.g., in the form of a UUID (Step 2). The AMF/IEF responds with an ActivatelEFResponse message (Step 3). Notably, this ActivatelEFResponse message indicates the ID of the activated IEF. For example, the ActivatelEFResponse message may be modified as below, based on ETSI TS 103 221-1:

ActivateIEFResponse message

| ETSI TS 103 221-1 | | |
|---|---|---|
| field name | Description | M/C/O |
| OK or Error | The general errors in clause 6.7 of ETSI TS | M |
| | 103 221-1 apply. Also, it is an error if | |
| | the XID is already present at the NE | |
| IEFId | Shall contain a IIEFId, present only in | C |
| | successful case | |

FIG. 5 shows that the AMF/IEF may thereafter receive a new association/disassociation event (Step 4). In response to the event, the AMF/IEF transmits an IEFAssociationRecord message to the ICF reporting the event, e.g., over an LI_XER interface. The IEFAssociationRecord message indicates the IEFid reporting the event.

More particularly, according to some embodiments, and based on TS 33.128 clause 6.2.2A.2.2, for each association event, the IEF shall create an IEFAssociationRecord, as defined below:

TABLE 6.2.2A-1
Payload for IEFAssociationRecord

| Field name | Description | M/C/O |
|---|---|---|
| sUPI | SUPI associated with detected association event. | M |
| fiveGGUTI | 5G-GUTI shall be provided. | M |
| | Encoded as per TS 24.501 FIG. | |
| | 9.11.3.4.1, omitting the first four octets. | |
| timeStamp | Time at which the identifier | M |
| | association event occurred. | |
| | Shall be given qualified with time | |
| | zone information (i.e. as UTC or | |
| | offset from UTC, not as local time). | |
| tAI | Last known tracking area ID (TAI) | M |
| | associated with the SUPI. | |
| | Encoded as per TS 24.501 clause | |
| | 9.1.3.8, omitting the first octet. | |
| nCGI | Last known nCGI(s) (cell global | M |
| | identit(ies)) available when | |
| | identifier association event detected. | |
| | Given as a sequence of public | |
| | land mobile network ID (PLMNID) | |
| | (encoded as per TS 38.413 | |
| | clause 9.3.3.5) and NR cell identifier | |
| | (NCI) (encoded as per TS | |
| | 38.413 clause 9.3.1.7). | |
| nCGITime | ueLocationTimestamp(s) of nCGIs | M |
| | if available in AMF as per TS 29 | |
| | 571 clause 5.4.4.9. | |
| | If ueLocationTimestamp(s) is not | |
| | available, shall be populated with | |
| | timeStamp(s) of when last known | |
| | nCGI(s), were obtained and | |
| | stored by the AMF. | |
| sUCI | SUCI shall be provided when event | C |
| | is triggered by association of a | |
| | SUCI to a SUPI. | |
| pEI | PEI, (See NOTE 1). | C |
| fiveGSTAIList | List of tracking areas associated | C |
| | with the registration area within | |
| | which the UE is current registered, | |
| | see TS 24.501, clause 9.11.3.4. | |
| | (See NOTE 2) | |
| iEFId | Identity of the IEF reporting the | C |
| | association to the ICF | |

NOTE 1:
Shall be provided in first association record to ICF after PEI is available and following any change of PEI.
NOTE 2:
As a minimum, list of tracking areas shall be included in the first association event for each SUPI registered (per UE session) with the AMF and additionally whenever the TAI list changes due to a change in registration area.

The related ASNA1 schema, specified in Annex F of TS 33.128 will then be modified as follows:

IEFAssociationRecord ::= SEQUENCE
{

| | |
|---|---|
| sUPI | [1] SUPI, |
| fiveGGUTI | [2] FiveGGUTI, |
| timestamp | [3] GeneralizedTime, |
| tAI | [4] TAI, |
| nCGI | [5] NCGI, |
| nCGITime | [6] GeneralizedTime, |
| sUCI | [7] SUCI OPTIONAL, |
| pEI | [8] PEI OPTIONAL, |
| fiveGSTAIList | [9] FiveGSTAIList OPTIONAL, |
| iEFId | [10]IEFId |

}

where a proper type definition of IEFId can be considered, e.g. it could be an UUID.

In any event, in response to the IEFAssociationRecord message, the ICF stores/updates the association records per IEFid (Step 6). Alternatively or additionally, the AMF/IEF may transmit an IEFDeAssociationRecord message to the ICF reporting a deassociation event (Step 7). The IEFDeAssociationRecord message similarly indicate the IEFid reporting the event.

With the association records stored at the ICF per IEFid, the LIPF as shown may request cache deletion on an IEFid basis. FIG. 5 in this regard shows that the LIPF may transmit, to the ICF, a DeletelCFCacheRequest message that includes a list of one or more IEFids for which associations shall be deleted or that indicates the associations related to all IEFs shall be deleted (Step 8). For example, the DeletelCFCacheRequest message may be specified as:

DeleteICFCacheRequest message

| Field name | Description | M/C/O |
|---|---|---|
| IEFIdList | Shall contain a list of IEFId, if the | C |
| | associations shall be deleted for one or | |
| | more specific IEFs | |
| All | Included if the associations related to all | C |
| | JEFs shall be deleted | |

The ICF thereafter deletes the association records of one or more IEFids according to the DeletelCFCacheRequest message (Step 9). The ICF may correspondingly transmit a DeletelCFCacheResponse message to the LIPF (Step 10), e.g., as specified below:

DeleteCFCacheResponse message

| Field name | Description | M/C/O |
|---|---|---|
| OK or Error | The general errors in clause 6.7 of ETSI | M |
| | TS 103 221-1 apply. | |

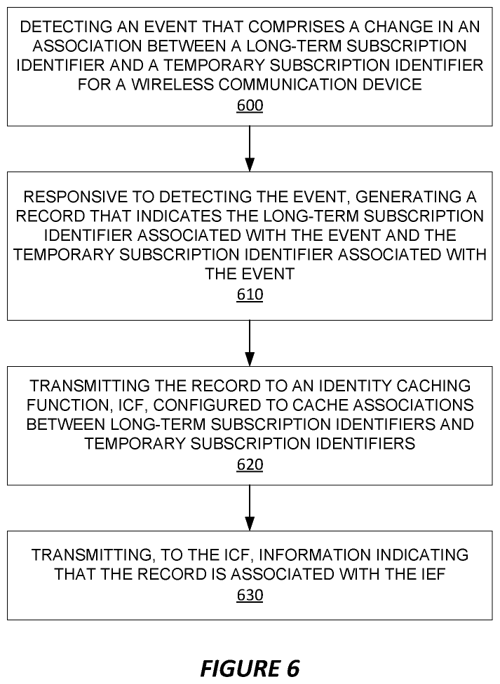

In view of the modifications and variations herein, FIG. 6 depicts a method performed by a network device configured to implement an Identity Event Function, IEF, 16 for lawful interception, LI, of communications in a wireless communication network 12 in accordance with particular embodiments. The method includes detecting an event that comprises a change in an association between a long-term subscription identifier and a temporary subscription identifier for a wireless communication device 14 (Block 600). The method also comprises, responsive to detecting the event, generating a record 22 that indicates the long-term subscription identifier (LID n) associated with the event and the temporary subscription identifier (TID n) associated with the event (Block 610). The method further comprises transmitting the record 22 to an Identity Caching Function, ICF, 18 configured to cache associations between long-term subscription identifiers and temporary subscription identifiers (Block 620). Notably, the method also comprises transmitting, to the ICF 18, information indicating that the record 22 is associated with the IEF 16 (Block 630).

In some embodiments, the information indicating that the record 22 is associated with the IEF 16 comprises an IEF identity 26. In one or more of these embodiments, the IEF identity 26 is included in the record 22, wherein the IEF identity 26 identifies the IEF 16, wherein the information is transmitted to the ICF 18 by transmitting the record 22 to the ICF 18. In one or more of these embodiments, transmitting the information comprises transmitting the IEF identity 26 to the ICF 18 in the same message as the record 22. In one or more of these embodiments, the IEF identity 26 is an identity of the network equipment. In one or more of these embodiments, the IEF identifier is a Universally Unique Identifier, UUID.

In some embodiments, the record 22 includes a first field that indicates the long-term subscription identifier (LID n) associated with the event, a second field that indicates the temporary subscription identifier (TID n) associated with the event, and a third field that includes the information indicating that the record 22 is associated with the IEF 16.

In some embodiments, the event is association of the temporary subscription identifier (TID n) to the long-term subscription identifier (LID n). Alternatively, the event is disassociation of the temporary subscription identifier (TID n) to the long-term subscription identifier (LID n).

In some embodiments, the long-term subscription identifier (LID n) is a Subscription Long-term Identifier, SUPI.

In some embodiments, the long-term subscription identifier (LID n) is an International Mobile Subscriber Identity, IMSI.

In some embodiments, the long-term subscription identifier (LID n) is a network specific identifier, a Global Line Identifier, GLI, or a Global Cable Identifier, GCI. In this case, the long-term subscription identifier takes the form of a Network Access Identifier.

In some embodiments, the temporary subscription identifier (TID n) is a 5G Global Unique Temporary Identifier, 5G-GUTI.

In some embodiments, the method further comprises generating the information indicating that the record 22 is associated with the IEF 16.

In some embodiments, the method further comprises receiving, from a LI Provisioning Function, LIPF, 20 a request 28 to activate the IEF 16, and transmitting, to the LIPF 20, a response 30 that indicates successful activation of the IEF 16 and that indicates an IEF identity 26 identifying the IEF 16.

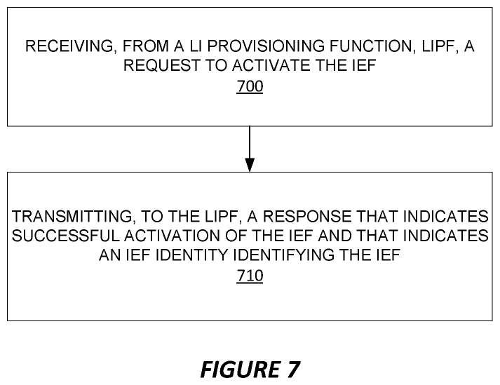

FIG. 7 depicts a method performed by a network device configured to implement an Identity Event Function, IEF, 16 for lawful interception, LI, of communications in a wireless communication network 12 in accordance with other particular embodiments. The method comprises receiving, from a LI Provisioning Function, LIPF, 20 a request 28 to activate the IEF 16 (Block 700). The method further comprises transmitting, to the LIPF 20, a response 30 that indicates successful activation of the IEF 16 and that indicates an IEF identity 26 identifying the IEF 16 (Block 710).

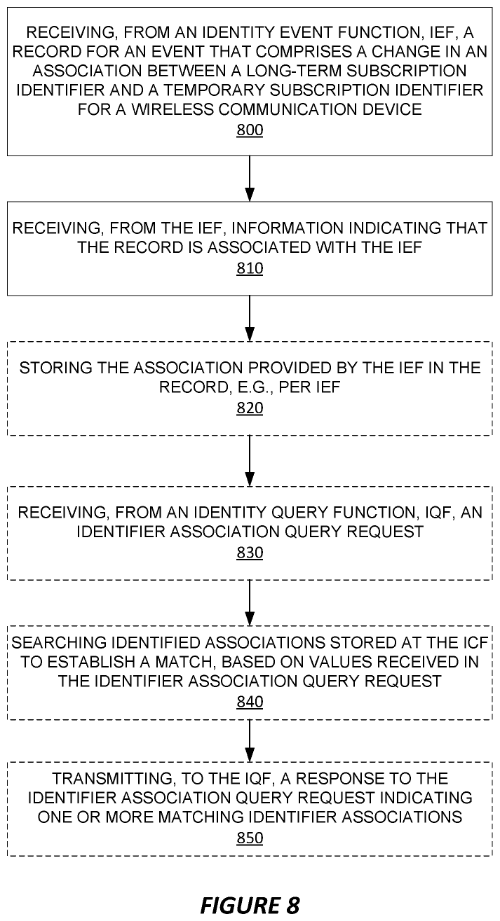

FIG. 8 depicts a method performed by a network device configured to implement an Identity Caching Function, ICF, 18 for lawful interception, LI, of communications in a wireless communication network 12. The method comprises receiving, from an Identity Event Function, IEF, 16 a record 22 for an event that comprises a change in an association between a long-term subscription identifier (LID n) and a temporary subscription identifier (TID n) for a wireless communication device 14 (Block 800). Here, the record 22 indicates the long-term subscription identifier associated with the event and the temporary subscription identifier associated with the event. The method also comprises receiving, from the IEF 16, information indicating that the record 22 is associated with the IEF 16 (Block 810).

In some embodiments, the method further comprises storing the association provided by the IEF 16 in the record 22, e.g., per IEF (Block 820). For example, the method may comprise storing the association in association with an IEF identity 26 that identifies the IEF 16.

In some embodiments, the method further comprises receiving, from an Identity Query Function, IQF, an identifier association query request (Block 830), searching identified associations stored at the ICF to establish a match, based on values received in the identifier association query request (Block 840), and transmitting, to the IQF, a response to the identifier association query request indicating one or more matching identifier associations (Block 850).

In some embodiments, the information indicating that the record 22 is associated with the IEF 16 comprises an IEF identity 26. In one or more of these embodiments, the IEF identity 26 is included in the record 22. In this case, the IEF identity 26 identifies the IEF 16, and the information is received from the ICF 18 by receiving the record 22 from the ICF 18. In one or more of these embodiments, receiving the information comprises receiving the IEF identity 26 from the ICF 18 in the same message as the record 22. In one or more of these embodiments, the IEF identity 26 is an identity of the network equipment. In one or more of these embodiments, the IEF identifier is a Universally Unique Identifier, UUID.

In some embodiments, the record 22 includes a first field that indicates the long-term subscription identifier (LID n) associated with the event, a second field that indicates the temporary subscription identifier (TID n) associated with the event, and a third field that includes the information indicating that the record 22 is associated with the IEF 16.

In some embodiments, the event is association of the temporary subscription identifier (TID n) to the long-term subscription identifier (LID n). Alternatively, the event is disassociation of the temporary subscription identifier (TID n) to the long-term subscription identifier (LID n).

In some embodiments, the long-term subscription identifier (LID n) is a Subscription Long-term Identifier, SUPI.

In some embodiments, the long-term subscription identifier (LID n) is an International Mobile Subscriber Identity, IMSI.

In some embodiments, the long-term subscription identifier (LID n) is a network specific identifier, a Global Line Identifier, GLI, or a Global Cable Identifier, GCI. In this case, the long-term subscription identifier (LID n) takes the form of a Network Access Identifier.

In some embodiments, the temporary subscription identifier (TID n) is a 5G Global Unique Temporary Identifier, 5G-GUTI.

In some embodiments, the method further comprises receiving a request 32 to delete any identifier associations received in events for one or more IEFs 16. In one or more of these embodiments, the request 32 includes one or more respective IEF identities 34 that identify the one or more IEFs 16. In one or more of these embodiments, the request 32 is a request 32 to delete any identifier associations received in events for all IEFs 16. In one or more of these embodiments, the method further comprises responsive to the request 32, deleting any identifier associations received in events for the one or more IEFs 16.

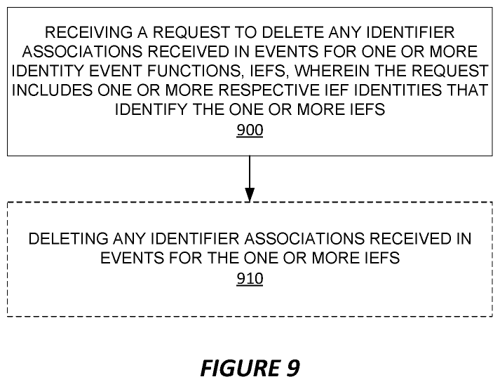

FIG. 9 depicts a method performed by a network device configured to implement an Identity Caching Function, ICF, 18 for lawful interception, LI, of communications in a wireless communication network 12 in accordance with other embodiments. The method comprises receiving a request 32 to delete any identifier associations received in events for one or more Identity Event Functions, IEFs, 16, where the request 32 includes one or more respective IEF identities 34 that identify the one or more IEFs (Block 900).

In some embodiments, the method further comprises deleting any identifier associations received in events for the one or more IEFs (Block 910).

In some embodiments, the long-term subscription identifier (LID n) is a Subscription Long-term Identifier, SUPI.

In some embodiments, the long-term subscription identifier (LID n) is an International Mobile Subscriber Identity, IMSI.

In some embodiments, the long-term subscription identifier (LID n) is a network specific identifier, a Global Line Identifier, GLI, or a Global Cable Identifier, GCI. In this case, the long-term subscription identifier (LID n) takes the form of a Network Access Identifier.

In some embodiments, the temporary subscription identifier (TID n) is a 5G Global Unique Temporary Identifier, 5G-GUTI.

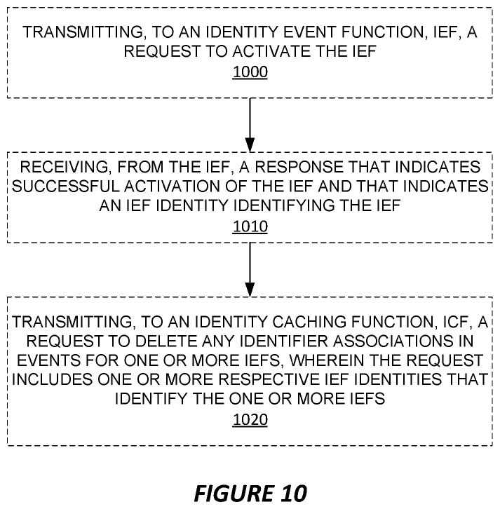

FIG. 10 depicts a method performed by a network device configured to implement a Lawful Interception Provisioning Function, LIPF, 20 for lawful interception, LI, of communications in a wireless communication network 12 according to some embodiments. In one embodiment, the method comprises transmitting, to an Identity Event Function, IEF, 16 a request 28 to activate the IEF 16 (Block 1000). The method may further comprise receiving, from the IEF 16, a response 30 that indicates successful activation of the IEF 16 and that indicates an IEF identity 26 identifying the IEF 16 (Block 1010).

In some embodiments, the IEF identity 26 is an identity of network equipment that implements the IEF 16.

In some embodiments, the IEF identity 26 is a Universally Unique Identifier, UUID.

Alternatively or additionally, the method may comprise transmitting, to an Identity Caching Function, ICF, 18 a request 32 to delete any identifier associations in events for one or more IEFs 16 (Block 1020). In some embodiments, the request 32 includes one or more respective IEF identities 34 that identify the one or more IEFs 16.

In some embodiments, the one or more IEF identities 34 are one or more identities of one or more network equipment that implement the one or more IEFs 16.

In some embodiments, the one or more IEF identities 34 are each a Universally Unique Identifier, UUID.

In some embodiments, the long-term subscription identifier (LID n) is a Subscription Long-term Identifier, SUPI.

In some embodiments, the long-term subscription identifier (LID n) is an International Mobile Subscriber Identity, IMSI.

In some embodiments, the long-term subscription identifier (LID n) is a network specific identifier, a Global Line Identifier, GLI, or a Global Cable Identifier, GCI. In this case, the long-term subscription identifier (LID n) takes the form of a Network Access Identifier.

In some embodiments, the temporary subscription identifier (TID n) is a 5G Global Unique Temporary Identifier, 5G-GUTI.

Embodiments herein also include corresponding apparatuses. Embodiments herein for instance include a network device configured to perform any of the steps of any of the embodiments described above for the IEF 16, ICF 18, and/or LIPF 20.

Embodiments also include a network device comprising processing circuitry and power supply circuitry. The processing circuitry is configured to perform any of the steps of any of the embodiments described above for the IEF 16, ICF 18, and/or LIPF 20. The power supply circuitry is configured to supply power to the network device.

Embodiments further include a network device comprising processing circuitry. The processing circuitry is configured to perform any of the steps of any of the embodiments described above for the IEF 16, ICF 18, and/or LIPF 20. In some embodiments, the network device further comprises communication circuitry.

Embodiments further include a network device comprising processing circuitry and memory. The memory contains instructions executable by the processing circuitry whereby the network device is configured to perform any of the steps of any of the embodiments described above for the IEF 16, ICF 18, and/or LIPF 20.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

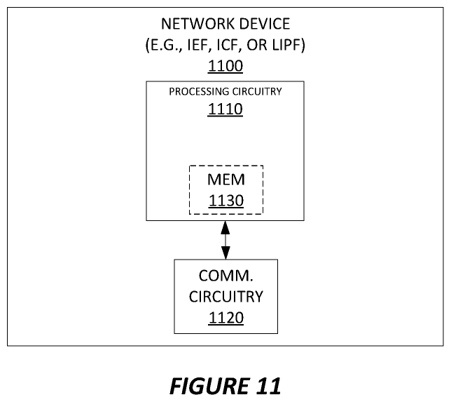

FIG. 11 for example illustrates a network device 1100 as implemented in accordance with one or more embodiments. The network device 1100 may for example implement the IEF 16, the ICF 18, and/or the LIPF 20 shown in FIG. 1. As shown, the network device 1100 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in any of FIGS. 6-10, such as by executing instructions stored in memory 1130. The processing circuitry 1110 in this regard may implement certain functional means, units, or modules.

Those skilled in the art will also appreciate that embodiments herein further include corresponding computer programs.

A computer program comprises instructions which, when executed on at least one processor of a network device, cause the network device to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

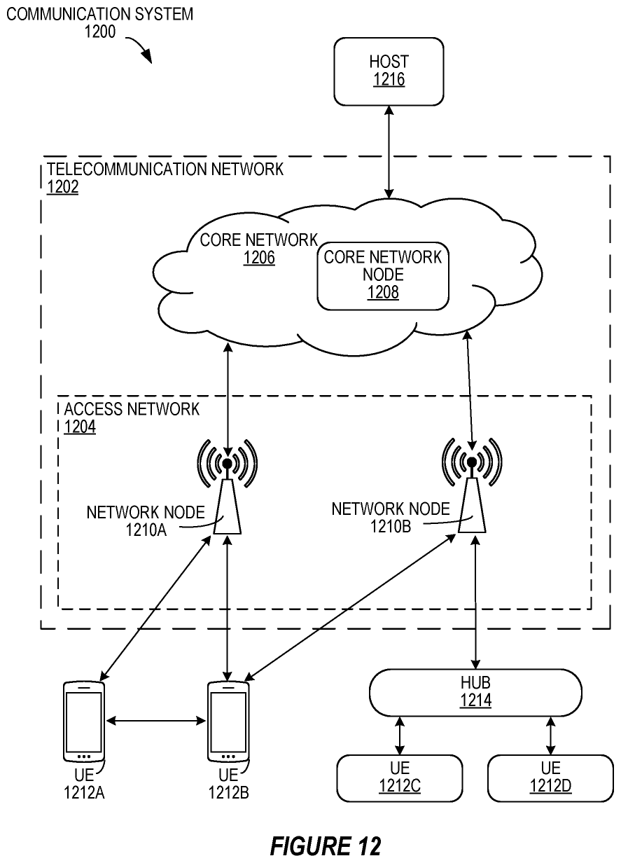

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

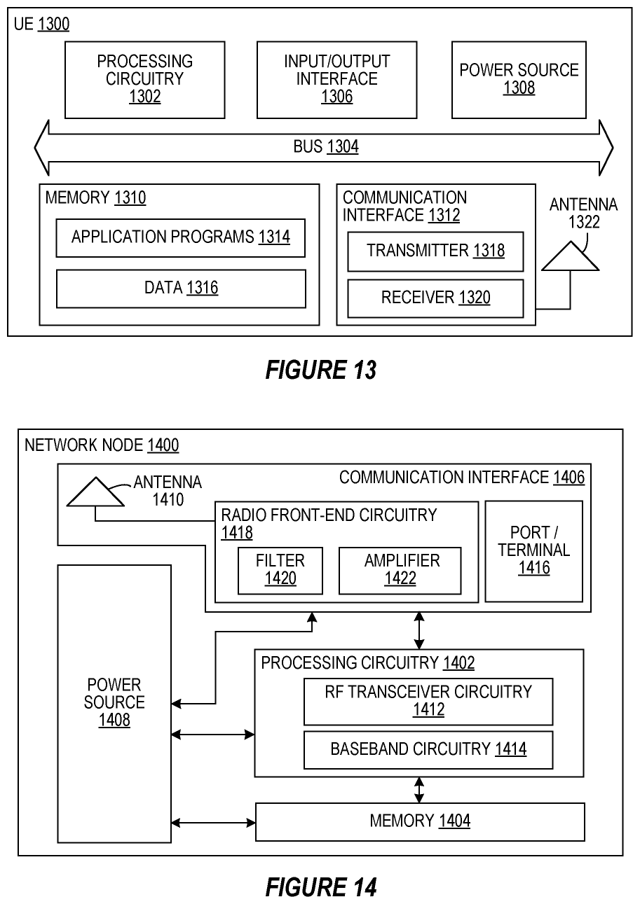

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

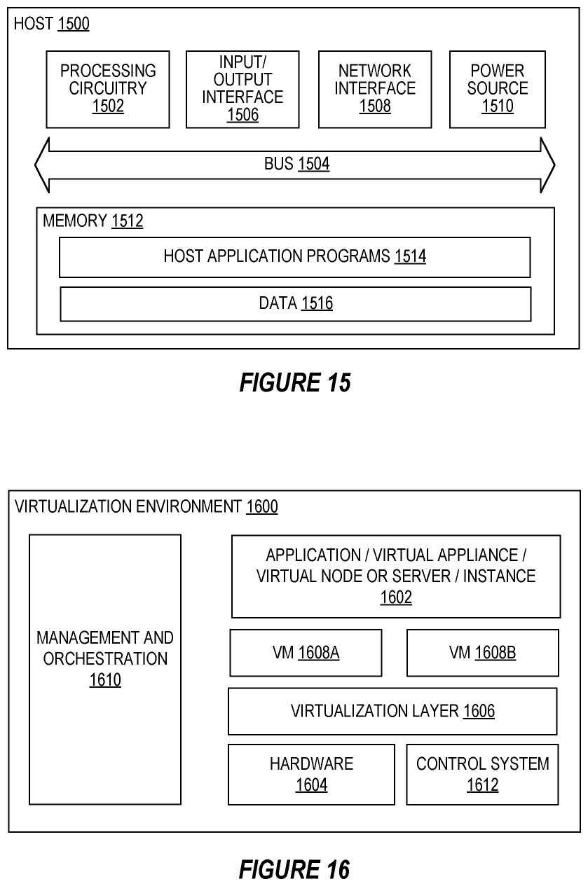

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

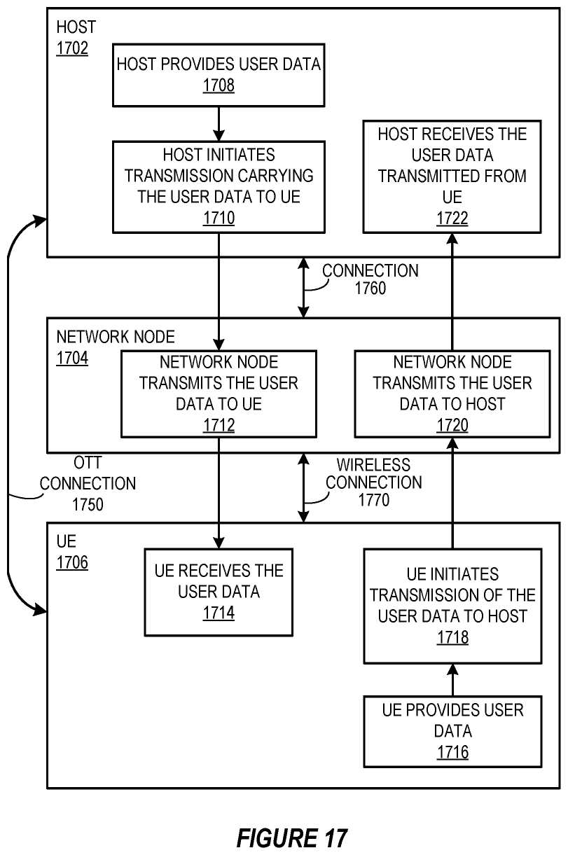

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-37. (canceled)

38. A method performed by a network device configured to implement an Identity Event Function (IEF) for lawful interception (LI) of communications in a wireless communication network, the method comprising:
detecting an event that comprises a change in an association between a long-term subscription identifier and a temporary subscription identifier for a wireless communication device;
responsive to detecting the event, generating a record that indicates the long-term subscription identifier associated with the event and the temporary subscription identifier associated with the event;
transmitting the record to an Identity Caching Function (ICF) configured to cache associations between long-term subscription identifiers and temporary subscription identifiers; and
transmitting, to the ICF, information indicating that the record is associated with the IEF wherein the information comprises an IEF identity.

39. The method of claim 38, wherein either:
the IEF identity is included in the record, wherein the IEF identity identifies the IEF, wherein the information is transmitted to the ICF by transmitting the record to the ICF; or
transmitting the information comprises transmitting the IEF identity to the ICF in the same message as the record.

40. The method of claim 38, wherein the IEF identity is an identity of the network device.

41. The method of claim 38, wherein the record includes a first field that indicates the long-term subscription identifier associated with the event, a second field that indicates the temporary subscription identifier associated with the event, and a third field that includes the information indicating that the record is associated with the IEF.

42. The method of claim 38, wherein the event is:
association of the temporary subscription identifier to the long-term subscription identifier; or
disassociation of the temporary subscription identifier to the long-term subscription identifier.

43. The method of claim 38, further comprising:
receiving, from a LI Provisioning Function (LIPF), a request to activate the IEF; and
transmitting, to the LIPF, a response that indicates successful activation of the IEF and that indicates an IEF identity identifying the IEF.

44. A method performed by a network device configured to implement an Identity Caching Function (ICF) for lawful interception (LI) of communications in a wireless communication network, the method comprising:
receiving, from an Identity Event Function (IEF), a record for an event that comprises a change in an association between a long-term subscription identifier and a temporary subscription identifier for a wireless communication device, wherein the record indicates the long-term subscription identifier associated with the event and the temporary subscription identifier associated with the event; and
receiving, from the IEF, information indicating that the record is associated with the IEF wherein the information comprises an IEF identity.

45. The method of claim 44, wherein either:
the IEF identity is included in the record, wherein the IEF identity identifies the IEF, wherein the information is received from the ICF by receiving the record from the ICF; or
receiving the information comprises receiving the IEF identity from the ICF in the same message as the record.

46. The method of claim 44, wherein the IEF identity is an identity of a network device implementing the IEF.

47. The method of claim 44, wherein the record includes a first field that indicates the long-term subscription identifier associated with the event, a second field that indicates the temporary subscription identifier associated with the event, and a third field that includes the information indicating that the record is associated with the IEF.

48. The method of claim 44, wherein the event is:
association of the temporary subscription identifier to the long-term subscription identifier; or
disassociation of the temporary subscription identifier to the long-term subscription identifier.

49. The method of claim 44, further comprising storing the association provided by the IEF in the record.

50. The method of claim 49, wherein storing the association comprises storing the association per IEF or storing the association in association with an IEF identity that identifies the IEF.

51. The method of claim 49, further comprising:
receiving, from an Identity Query Function (IQF), an identifier association query request;
searching identified associations stored at the ICF to establish a match, based on values received in the identifier association query request; and
transmitting, to the IQF, a response to the identifier association query request indicating one or more matching identifier associations.

52. The method of claim 44, further comprising receiving a request to delete any identifier associations received in events for one or more IEFs and, responsive to the request, deleting any identifier associations received in events for the one or more IEFs.

53. The method of claim 52, wherein the request includes one or more respective IEF identities that identify the one or more IEFs or is a request to delete any identifier associations received in events for all IEFs.

54. A network device configured to implement an Identity Event Function (IEF) for lawful interception (LI) of communications in a wireless communication network, the network device comprising:
communication circuitry; and
processing circuitry configured to:
detect an event that comprises a change in an association between a long-term subscription identifier and a temporary subscription identifier for a wireless communication device;
responsive to detecting the event, generate a record that indicates the long-term subscription identifier associated with the event and the temporary subscription identifier associated with the event;
transmit the record to an Identity Caching Function (ICF) configured to cache associations between long-term subscription identifiers and temporary subscription identifiers; and
transmit, to the ICF, information indicating that the record is associated with the IEF wherein the information comprises an IEF identity.

55. The network device of claim 54, wherein either:
the IEF identity is included in the record, wherein the IEF identity identifies the IEF, wherein the processing circuitry is configured to transmit the information to the ICF by transmitting the record to the ICF; or
the processing circuitry is configured to transmit the information by transmitting the IEF identity to the ICF in the same message as the record.

56. A network device configured to implement an Identity Caching Function (ICF) for lawful interception (LI) of communications in a wireless communication network, the network device the network device comprising:
communication circuitry; and
processing circuitry configured to:
receive, from an Identity Event Function (IEF), a record for an event that comprises a change in an association between a long-term subscription identifier and a temporary subscription identifier for a wireless communication device, wherein the record indicates the long-term subscription identifier associated with the event and the temporary subscription identifier associated with the event; and
receive, from the IEF, information indicating that the record is associated with the IEF wherein the information comprises an IEF identity.

57. The network device of claim 56, wherein either:
the IEF identity is included in the record, wherein the IEF identity identifies the IEF, wherein the processing circuitry is configured to receive the information from the ICF by receiving the record from the ICF; or
the processing circuitry is configured to receive the information by receiving the IEF identity from the ICF in the same message as the record.
